(19) United States
(12) Patent Application Publication
(10) Pub. No.: US 2013/0217334 A1
(43) Pub. Date: Aug. 22, 2013

(54) FAST ACCESS SHORT-RANGE COMMUNICATION SYSTEM AND METHOD

(71) Applicant: NATIONZ TECHNOLOGIES INC., (US)

(72) Inventors: Yunbo YU, Shenzhen (CN); Shan ZHU, Shenzhen (CN)

(73) Assignee: NATIONZ TECHNOLOGIES INC., Shenzhen (CN)

(21) Appl. No.: 13/846,914

(22) Filed: Mar. 18, 2013

Related U.S. Application Data
(63) Continuation of application No. PCT/CN2010/079458, filed on Dec. 6, 2010.
Application No. PCT/CN2010/079458 is a continuation of application No. PCT/CN2010/079461, filed on Dec. 6, 2010.

(30) Foreign Application Priority Data
Sep. 21, 2010 (CN) 201010288016.9
Sep. 21, 2010 (CN) 201010288017.3

(51) Int. Cl. H04W 76/02

(52) U.S. Cl. CPC H04W 76/02
USPC 455/41.2

(57) ABSTRACT

Systems, devices, and methods allow quick establishment of short-range, high-speed wireless communications between a host communication device and a slave communication device, where range control is realized through a low-speed connection using signals (such as magnetic signals or ultrasonic signals) different from the high-speed communications. The host communication device includes: a reference unit, a first wireless communication unit, and a first control unit. The reference unit is configured to send a first range reference signal to control a communication range of the wireless communication connection. The slave communication device configured to determine whether the distance satisfies a predetermined range according to the received first range reference signal, and if so, the host communication device and slave communication device quickly establish a wireless communication connection and exchange data according to a predetermined protocol.

### CROSS-REFERENCE TO RELATED APPLICATIONS

The present application is a continuation of PCT/CN2010/079458 and PCT/CN2010/079461, both filed on Dec. 6, 2010, which claim priority respectively to CN 201010288016.9 and CN 201010288017.3, both filed on Sep. 21, 2010. The disclosures of these applications are hereby incorporated by reference in their entirety.

### BACKGROUND

Computers and mobile devices may make extensive use of high-speed wireless transmission for data exchange. Commonly used technologies may include Wi-Fi (e.g., IEEE802.11a/b/g/n standard), Bluetooth, Zigbee (IEEE 802.15.4 standard), Ultra Wideband (UWB) technologies, etc. These high-speed wireless communication technologies enable information exchange, function sharing, etc. among computers or mobile devices, where users can achieve operations of streaming file transfer, address book exchange, shared access to the Internet, etc.

### SUMMARY

In an aspect, a communication device is provided comprising: a reference unit; a first wireless communication unit; and a first control unit configured to control the reference unit and the first wireless communication unit; wherein the first wireless communication unit is configured to establish a wireless communication connection and perform data exchange according to a predetermined protocol; and wherein the reference unit is configured to send a first range reference signal wirelessly to thereby control a communication range of the wireless communication connection.

In some implementations, a rate at which the first wireless communication unit establishes the wireless communication connection and performs data exchange is higher than a rate at which the reference unit transmits the first range reference signal.

In some implementations, the first range reference signal contains information about the communication device and information about the communication range.

In some implementations, the first range reference signal comprises a low-frequency magnetic signal having a frequency selected from 500 Hz, 1 kHz, 1.5 kHz, 2 kHz, 2.5 kHz, 3 kHz, 4 kHz, 5 kHz, 10 kHz, 20 kHz, 30 kHz, or 10 MHz.

In some implementations, the communication device further includes: a first micro-controller; a first encoder circuit; a first drive circuit; and a first magnetic field transmitter coil; wherein the first micro-controller is configured to control the first encoder circuit and the first drive circuit; wherein the first encoder circuit is configured to conduct bit-wise encoding of wireless data frame of the information about the communication device and transmit it to the first drive circuit; wherein the first drive circuit is configured to drive the first magnetic field transmitter coil; and wherein the first magnetic field transmitter coil is configured to generate the first range reference signal.

In some implementations, the communication device further include a first modulation circuit disposed between the first encoder circuit and the first drive circuit, wherein the first modulation circuit is configured to modulate the information about the communication device after it has been encoded by the first encoder circuit, and to transmit the information to the first drive circuit.

In some implementations, the reference unit include: a second magnetic induction circuit; a second amplification circuit; and a second threshold determination and demodulation circuit; wherein the second magnetic induction circuit is configured to: sense and receive a second range reference signal containing information about the source of the signal; convert it into an electrical signal; and transmit it to the second amplification circuit; wherein the second amplification circuit is configured to amplify the second reference signal and transmit it to the second threshold determination and demodulation circuit; wherein the second threshold determination and demodulation circuit is configured to determine whether the second range reference signal has reached a preset threshold value, if so, then the information about the source of the signal included in the second range reference signal is sent to the first micro-controller; and wherein the first micro-controller is configured to: control the second magnetic induction circuit, the second amplification circuit, the second threshold determination and demodulation circuit; and transmit the received information about the source of the signal to the first control unit.

In some implementations, the first range reference signal comprises an ultrasonic signal.

In some implementations, the reference unit includes: at least three ultrasonic transmitters; and at least one modulation and start control device coupled to the at least three ultrasonic transmitters; wherein the modulation and start control device is configured to: modulate the information about the communication device into the first range reference signal; and start the at least three ultrasonic transmitters substantially simultaneously; wherein the at least three ultrasonic transmitters are configured to separately transmit the first range reference signal in the form of ultrasonic waves of different frequencies.

In some implementations, the first wireless communication unit is configured to operate at a frequency band selected from 433 MHz, 900 MHz, 2.4 GHz, 5.8 GHz, or 60 GHz, and wherein the data exchange is performed after the reference unit sends the first range reference signal, or at intervals of the transmission of the first range reference signal.

In another aspect, a communication system is provided including: a host communication device including: a reference unit; a first wireless communication unit; and a first control unit configured to control the reference unit and the first wireless communication unit; wherein the first wireless communication unit is configured to establish a wireless communication connection and perform data exchange according to a predetermined protocol; and wherein the reference unit is configured to send a first range reference signal wirelessly to thereby control a communication range of the wireless communication connection; and a slave communication device configured to determine whether a distance between the host communication device and the slave communication device satisfies a predetermined range according to the received first range reference signal, and if so, the host communication device and slave communication device quickly establish a wireless communication connection and exchange data according to a predetermined protocol.

In some implementations, the slave communication device includes: a measurement unit; a second wireless communication unit; and a slave control unit configured to control the measurement unit and the second wireless communication unit; wherein the measurement unit is configured to determine whether the distance satisfies the predetermined range according to the first range reference signal received from the reference unit, and if so, information about the host communication device contained in the first range reference signal is sent to the slave control unit; and wherein the slave communication device is configured to, after receiving the information about the host communication device, through the first wireless communication unit and the second wireless communication unit, establish the wireless communication between the host communication device and the slave communication device, and perform data exchange according to the predetermined protocol.

In some implementations, the measurement unit includes: a first magnetic induction circuit; a first amplification circuit; a first threshold determination and demodulation circuit; and a second micro-controller; wherein the first magnetic induction circuit is configured to: sense and receive the first range reference signal in the form of a magnetic signal; convert the magnetic signal into an electrical signal; and transmit the electrical signal to the first amplification circuit; wherein the first amplification circuit is configured to: amplify the first range reference signal; and transmit the amplified first range reference signal to the first threshold determination and demodulation circuit; wherein the first threshold determination and demodulation circuit is configured to determine whether the first range reference signal reaches a predetermined threshold value, and if so, the information about the host communication device contained in the first range reference signal is transmitted to the second micro-controller; and wherein the second micro-controller is configured to: control the first magnetic induction circuit, the first amplification circuit, the first threshold determination and demodulation circuit; and transmit the information about the host communication device to the slave communication device control unit.

In some implementations, the measurement unit further includes: a second encoder circuit; a second drive circuit; and a second magnetic field transmitter coil; wherein the second micro-controller is configured to control the second encoder circuit and the second drive circuit; wherein the second encoder circuit is configured for bit-wise encoding of wireless data frame of information about the slave communication device and transmitting it to the second drive circuit; wherein the second drive circuit is configured to drive the second magnetic field transmitter coil; and wherein the second magnetic field transmitter coil is configured to generate the second range reference signal that contains the information about the slave communication device and transmit it in the form of a magnetic signal.

In some implementations, the reference unit includes: at least three ultrasonic transmitters; and at least one modulation and start control device coupled to the at least three ultrasonic transmitters; wherein the modulation and start control device is configured to modulate the information about the host communication device into the first range reference signal, and start the at least three ultrasonic transmitters substantially simultaneously; wherein the at least three ultrasonic transmitters are configured to transmit ultrasonic first range reference signals of different ultrasonic frequencies; wherein the measurement unit includes: at least three ultrasonic receivers; and at least one demodulation and time comparison device coupled to the at least three ultrasonic receivers; wherein the at least three ultrasonic receivers are configured to: receive ultrasonic first range reference signals of different ultrasonic frequencies respectively; and transmit the first range reference signals to the demodulation and time comparison device; wherein the demodulation and time comparison device is configured to: demodulate the first range reference signals of different ultrasonic frequencies respectively; and determine whether the communication distance satisfies the predetermined range based on time differences of the first range reference signals of different frequencies reaching the measurement unit, and if so, the information about the host communication device contained in the first range reference signals is transmitted to the slave control unit.

In some implementations, the host communication device and the slave communication device are disposed respectively in different host apparatuses, wherein the host apparatuses are selected from desktop computers, notebook computers, tablet PCs, PDAs, mobile phones, digital cameras, digital video cameras, e-readers, audio and video playback devices, digital photo frames; or cars, trains, airplanes or ships that have interactive data exchange functions.

In another aspect, a method of communication between a host communication device and a slave communication device is provided, wherein the host communication device includes: a reference unit; a first wireless communication unit; and a first control unit configured to control the reference unit and the first wireless communication unit; wherein the first wireless communication unit is configured to establish a wireless communication connection and perform data exchange according to a predetermined protocol; and wherein the reference unit is configured to send a first range reference signal wirelessly to thereby control a communication range of the wireless communication connection; wherein the first range reference signal contains information about the host communication device and information about the communication range; and a slave communication device configured to determine whether a distance between the host communication device and the slave communication device satisfies a predetermined range according to the received first range reference signal, and if so, the host communication device and slave communication devices quickly establish a wireless communication connection and exchange data according to a predetermined protocol; the method including: Step A: the host communication device sending a range reference signal, the slave communication device receiving the range reference signal; Step B: the slave communication device determining whether the distance satisfies the predetermined range, and if so, executing Step C, otherwise, executing Step A; Step C: establishing wireless communication between the host communication device and the slave communication device and exchanging data.

In some implementations, Step A includes: Step A1: the host communicating device converting the information about the host communication device into the first range reference signal in the form of a low-frequency magnetic signal and transmitting the low-frequency magnetic signal, and executing step A2; Step A2: the slave communicating device receiving the low-frequency magnetic signal and converting it into an electrical signal, and executing step B; wherein Step B comprises: Step B1: the slave communicating device authenticating the host communication device according to information about the host communication device contained in the electrical signal; Step B2: the slave communication device determining the threshold value of the electrical signal, if the threshold value of the electrical signal is equal to or greater than the predetermined threshold value, then executing step C, otherwise, executing Step A1.

In some implementations, Step A includes: Step A1′: the host communication device converting the information about the host communication device into ultrasonic range reference signals of at least three different ultrasonic frequencies, and substantially simultaneously transmitting the ultrasonic signals of at least three different frequencies, and executing step A2′; Step A2′: the slave communication device receiving the ultrasonic signals of at least three different frequencies, and recording time differences of the ultrasonic signals of different frequencies reaching the slave communication device, and executing step B; wherein Step B includes: Step B1′: the slave communication device demodulating the ultrasonic signals and obtaining the information about the host communication device, and authenticating the host communication device according to the information about the host communication device; Step B2′: the slave communication device calculating the distance between the host communication device and the slave communication device according to the time differences, and determining whether distance between the host communication device and the slave communication device satisfies the predetermined range, and if so, executing step C, otherwise, executing step A1′.

In some implementations, Step C is selected from a first group, a second group, or a third group, wherein the first group includes: Step C1: the slave communication device sending back an access confirmation message of the slave communication device to the host communication device via the second wireless communication unit according to the received information about the host communication device; Step C2: the host communication device receiving the access confirmation message via the first wireless communication unit and establishing wireless communication between the host communication device and the slave communication device through the first wireless communication unit and the second wireless communication unit; wherein the access confirmation message contains information about the host communication device; wherein the second group includes: Step C1′: the slave communication device sending back the access confirmation message of the slave communication device to the host communication device via second wireless communication unit according to received information about the host communication device; Step C2′: the host communication device receiving the access confirmation message via the first wireless communication unit and stopping transmitting the range reference signals; and Step C3′: establishing the wireless communication between the host communication device and the slave communication device through the first wireless communication unit and the second wireless communication unit; wherein the third group includes: Step C1″: the slave communication device stopping receiving the range reference signal; Step C2″: the slave communication device sending back the access confirmation message of the slave communication device to the host communication device via the second wireless communication unit according to the received information about the host communication device; Step C3″: the host communication device receiving the access confirmation message via the first wireless communication unit, and establishing the wireless communication between the host communication device and the slave communication device through the first wireless communication unit and the second wireless communication unit.

### BRIEF DESCRIPTION OF THE DRAWINGS

FIG. 1 is a schematic diagram illustrating the host communication module and the slave communication of a system for fast access short range wireless communication with a controllable communication range according to some embodiments.

FIG. 2 is a schematic diagram illustrating one-way communications between the reference unit and the measurement unit according to some embodiments that adopt magnetic signals.

FIG. 3 is a schematic diagram illustrating two-way communications between the reference unit and the measurement unit according to some embodiments that adopt magnetic signals.

FIG. 4 is a schematic diagram illustrating communications between the reference unit and the measurement unit according to some embodiments that adopt ultrasonic signals.

FIG. 5 is a flowchart illustrating an example method of fast access short range communication with a controllable communication range according to some embodiments.

FIG. 6 is a schematic diagram of an embodiment of the data exchange process according to some embodiments.

FIG. 7 is a flowchart illustrating an example method of fast access short range communication with a controllable communication range using magnetic signals according to some embodiments.

FIG. 8 is a flowchart illustrating an example method of fast access short range communication with a controllable communication range using ultrasonic signals according to some embodiments.

FIG. 9 is a flowchart illustrating an example method according to one embodiment.

FIG. 10 is a flowchart illustrating an example method according to another embodiment.

FIG. 11 is a flowchart illustrating an example method according to a third embodiment.

### DETAILED DESCRIPTION

Various embodiments are described in detail below with reference to the drawings. Like reference numbers may be used to denote like parts throughout the figures.

Some wireless technologies may target long-term, multi-user and long-range (e.g., over 10 meters) data exchange applications. When using these technologies, users may need to configure complicated settings. For example, users may need to perform cumbersome initial set-ups when using a mobile device for the first time, and may need to wait for a certain period of time to find and connect to the host machine when using the mobile device again. In addition, because these techniques need to take into consideration of situations where multiple users are working simultaneously, and factors such as poor quality of RF signals, complex link management protocols in the communication process are usually defined. As a result, these protocols may lead to low rate of utilization of wireless communication channels.

With the diversification of electronic mobile devices and their widespread applications, the demand for instant data sharing applications between two devices are becoming increasingly stronger. Embodiments disclosed herein provide data sharing between two devices that may be in close proximity (for example, within one meter), with fast, timely and highly efficient data exchange. The disclosed systems, methods, and device may also allow automatically connecting and transmitting data when slave devices enter a predetermined range of host devices, and automatically cutting off the connections when the slave devices move out of the predetermined range, etc.

In some technologies, radio-frequency identification (RFID) systems allow wireless communications within a specified range. RFID tags may be in the frequency bands of, for example, 13.56 MHz, 800-900 MHz, 2.4 GHz, etc. In an example, among which the reading and writing range for 13.56 M tags is less than 10 cm, while for the other two it can reach several meters. However, two problems exist with all of these RFID systems: the rate of transmission is overly low and the communication distance is not flexibly controllable; and these tags all adopt passive methods, which have high requirements for the transmitting power of the card reader, and are difficult to be integrated into light-weight mobile electronic devices.

Various embodiments disclosed herein may relate communications. A host communication module and a slave communication module may be employed to realize a fast and efficient short-range wireless communication system with a controllable communication range. For example, the host communication module can send a first range reference signal containing the information of the host communication module and information about communication range. From the slave communication module it may be determined whether the communication range satisfies a predetermined distance range according to the information contained in the received first range reference signal. If so, the slave communication module establishes a fast wireless communication connection according to a predetermined protocol and performs data exchange. The first range reference signal can take the form of a low frequency magnetic signal, or an ultrasonic signal, to satisfy the requirement of the short range access.

Fast access and highly efficient communications within a specific range may be achieved among a variety of devices. Complex access processes, cumbersome setups, and inefficient data exchange protocol overhead may be eliminated or reduced.

In some embodiments, the host communication module includes a reference unit, a first wireless communication unit, and a first control unit that controls the work of the reference unit and the first wireless communication unit. The reference unit can wirelessly transmit a first range reference signal. The first wireless communication unit can quickly establish a wireless communication connection according to a predetermined protocol and perform data exchange.

By transmitting the first range reference signal, the corresponding reception module or apparatus can determine whether it is within a predetermined range of communication distance according to this first range reference signal. If so, real-time, fast and efficient wireless communication and data exchange within the predetermined range may be established with the host communication module. The host communication modules according to some of the embodiments disclosed herein provide basic hardware carriers for fast and highly efficient short range wireless communications with a controllable range.

In some embodiments, the rate of the first wireless communication unit to establish wireless communication connection and exchanges data is higher than the rate of the reference unit to transmit the first range reference signal.

In some embodiments, the establishment of high-speed data transmission channels can be achieved using low-speed transmission channels through various methods of distance determination.

In some embodiments, the first range reference signal may include information about the host communication module and information about the communication distance. As such, the devices receiving the first range reference signal can identify the host communication module and determine the distance.

In some embodiments, the reference unit may include a first micro-controller, a first encoder circuit, a first drive circuit, and a first magnetic field transmitter coil that are serially connected. The first micro-controller can control the first encoder circuit and the first drive circuit. The first encoder circuit can conduct bit-wise encoding of wireless data frame of the host communication module information and transmit it to the first drive circuit. The first drive circuit can drive the first magnetic field transmitter coil. The first magnetic field transmitter coil can generate the first range reference signal containing the host communication module information and transmit it in the form of a magnetic signal.

In some embodiments, the reference unit further includes a first modulation circuit positioned between the first encoder circuit and the first driver circuit. The first modulation circuit can modulate the host communication module information after it has been encoded by the first encoder circuit, and transmit the information to the first drive circuit. As such, the host communication module information can be modulated as desired.

In some embodiments, the reference unit further includes a second magnetic induction circuit, a second amplification circuit, and a second threshold determination and demodulation circuit. The second magnetic induction circuit, the second amplification circuit, the second threshold determination and demodulation circuit, and the first micro-controller may be serially connected. The second magnetic induction circuit can sense and receive the second range reference signal including the information about the signal source in the form of a magnetic signal and convert it into an electrical signal, and transmit it to the second amplification circuit. The second amplification circuit can amplify the second reference signal and transmit it to the second threshold determination and demodulation circuit. The second threshold determination and demodulation circuit can determine whether the second range reference signal has reached a predetermined threshold value. If so, the signal transmission source information included in the second range reference signal may be sent to the first micro-controller. The first micro-controller can control the second magnetic induction circuit, the second amplification circuit, the second threshold determination and demodulation circuit, and transmit the information about the signal transmission source to the first control unit.

Advantageously, a channel to authenticate the communication distance between the host communication module and other sources of signal transmission may be provided, such that the host communication module has the function of detecting the communication distance between itself and other sources of signal transmission.

In some embodiments, the first range reference signal is a low-frequency magnetic signal. Using magnetic signals, the communication distance may be calculated based on the physics measure of magnetic flux density, which can decrease at the rate of R⁻³ with the communication distance R. The low frequency magnetic signals may have low attenuation when penetrating different objects, and strong anti-interference capability. Some embodiments disclosed herein provide a robust magnetic communication, with a high security level of the transmission of the first range reference signal between the host communication module and the slave communication.

In some embodiments, the frequency of the low-frequency magnetic signal may be, for example, 500 Hz, 1 KHz, 1.5 KHz, 2 KHz, 2.5 KHz, 3 KHz, 4 KHz, 5 KHz, 10 KHz, 20 KHz, 30 KHz, or 10 MHz.

In some embodiments, the second range reference signal may be a low frequency magnetic signal, with a frequency of, for example, 500 Hz, 1 KHz, 1.5 KHz, 2 KHz, 2.5 KHz, 3 KHz, 4 KHz, 5 KHz, 10 KHz, 20 KHz, 30KHz, or 10 MHz.

In some other embodiments, the reference unit includes at least three ultrasonic transmitters and at least one modulation and start control device. The modulation and start control device can modulate the information about the host communication module into the first range reference signal, and start the at least three ultrasonic transmitters. The at least three ultrasonic transmitters can separately transmit the first range reference signals of different frequencies in an ultrasonic wave form. In these embodiments, the first range reference signal is transmitted using an ultrasonic signal as a carrier. Advantageously, accurate communication distance control can be achieved using an ultrasonic signal, and controllable communication range can reach a few meters or even farther. Precise control of the communication may also be within the range of, for example, 1 m, 0.5 m, or even 10 cm. Using ultrasonic signals allow real-time, high-speed data exchanges between desktop electronic devices, as well as real-time, high-speed data exchanges between different vehicles, and between vehicles and gate readers. The mutual interference between the ultrasonic waves and the communication signals of the first wireless communication unit may be very small.

In some embodiments, the first wireless communication unit may be a Wi-Fi module, a Bluetooth module, or an UWB module. The data exchange and communication between the host communication module and other communication devices can be in various forms, meeting various communication needs.

In some embodiments, the wireless communication frequency bands of the first wireless communication unit may be, for example, 433 MHz, 900 MHz, 2.4 GHz, 5.8 GHz, or 60 GHz. High-speed communication and data exchange may be realized in these frequency bands.

In some embodiments, the transmission of the first range reference signal by the reference unit is not carried out simultaneously with the quick establishment of wireless communication and the performance of data exchange according to a predetermined protocol. For example, the transmission of the first range reference signal and the establishment of communication connection and data exchange are carried out separately.

In some embodiments, i.e., the transmission of the first range reference signal is stopped when a communication connection is established and data exchange is performed, such that the transmission of the first range reference signal does not have to be carried out all the time, thereby preventing the signals from interfering with each other and improving the transmission efficiency and measurement accuracy. The system may have simple structures, is easy to operate, and can save system resources.

In some embodiments, the reference unit sends the first range reference signal before the wireless communication connection is quickly established according to a predetermined protocol and data exchange is performed. Advantageously, interferences among signals may be reduced, and transmission efficiency and measurement accuracy may be improved.

In some embodiments, the reference unit intermittently transmits first range reference signals, and the first wireless communication unit performs fast data exchange at the intervals of the transmission of the reference signals. These embodiments may also have the advantages that interferences among signals may be reduced, and transmission efficiency and measurement accuracy may be improved.

In some embodiments, the slave communication module comprises a measurement unit, a second wireless communication unit, and a second control unit that controls the work of the measurement unit and the second wireless communication unit. The measurement unit can receive the first range reference signal and determine whether the communication distance between the slave communication module and the source of the reference signal satisfies the predetermined range. If so, the second wireless communication unit quickly establishes a wireless communication connection and performs data exchange according to a predetermined protocol.

Through the first range reference signal, it may be determined whether the distance between the slave communication module and the source of the signal transmission is within a predetermined range. If so, instant, fast, efficient wireless communication and data exchange can be achieved in the predetermined range. The slave communication module provides basic hardware carrier for fast and efficient near range wireless communications with a controllable communication range.

In some embodiments, the rate at which the second wireless communication unit establishes the wireless communication connection and exchanges data is higher than the rate at which the measurement unit receives the first range reference signal. As such, the establishment of high-speed data transmission channel can be achieved using the low-speed transmission channel with the method of distance determination.

In some embodiments, the first range reference signal contains information about the source of the signal transmission and information about the communication distance, thereby facilitating the slave communication module to detect the source of signal transmission and determine the distance.

In some embodiments, the measurement unit comprises serially-connected a first magnetic induction circuit, a first amplification circuit, a first threshold determination circuit, a demodulation circuit, and a second micro-controller. The first magnetic induction circuit can sense and receive the first range reference signal in the form of a magnetic signal, convert it into an electrical signal, and send it to the first amplification circuit. The first amplification circuit can amplify the first range reference signal and send it to the first threshold determination and demodulation circuit. The first threshold determination and demodulation circuit can determine whether the first range reference signal reaches the predetermined threshold value. If so, the signal transmission source information contained in the first range reference signal is sent to the second micro-controller. The second micro-controller can control the first magnetic induction circuit, the first amplification circuit, the first threshold determination and demodulation circuit, and transmit the information about the source of signal to the second control unit.

Advantageously, a channel is provided to validate the communication distance between the slave communication module and the source of signal transmission. A predetermined transmission power of the magnetic signal can enable the distance threshold value to directly reflect the communication distance between the host module and the slave module, thus facilitating the slave module to determine the distance.

In some embodiments, the slave module can also send a second range reference signal to the host module, thereby realizing a two-way communication and a two-way authentication of the magnetic range reference signals between the reference unit and measurement unit.

In some embodiments, the measurement unit further comprises a second encoder circuit, a second drive circuit, and a second magnetic field transmitter coil. The second micro-controller, the second encoder circuit, the second drive circuit, and the second magnetic field transmitter coil may be serially connected. The second micro-controller can control the second encoder circuit and the second drive circuit. The second encoder circuit can be used for bit-wise encoding of the wireless data frame of the information about the slave communication module, and for transmitting it to the second drive circuit. The second drive circuit can drive the second magnetic field transmitter coil, which can generate a second range reference signal containing the information about the slave communication module, and transmit it in the form of a magnetic signal.

Advantageously, the slave communication module also provides an approach to transmit the second range reference signal using the magnetic signal as a carrier, thereby facilitating the corresponding receiving module or apparatus to receive and determine the distance between itself and the slave communication module.

In some embodiments, the measurement unit further includes a second modulation circuit positioned between the second encoder circuit and the second drive circuit. The second modulation circuit can modulate the information about the slave communication module after it has been encoded by the second encoder circuit, and transmit it to the second drive circuit. Accordingly, modulating the information about the slave communication module can be achieved as needed.

In some embodiments, the first range reference signal can be a low-frequency magnetic signal. The frequencies of the low-frequency magnetic signal can be, for example, 500 Hz, 1 kHz, 1.5 kHz, 2 kHz, 2.5 kHz, 3 kHz, 4 kHz, 5 kHz, 10 kHz, 20 kHz, 30 kHz, or 10 MHz. In some embodiments, the second reference signal may be a low frequency magnetic signal with a frequency of, for example, 500 Hz, 1 kHz, 1.5 kHz, 2 kHz, 2.5 kHz, 3 kHz, 4 kHz, 5 kHz, 10 kHz, 20 kHz, 30 kHz, or 10 MHz.

In some other embodiments, the measurement unit includes at least three ultrasonic receivers, and one or more demodulation and time comparison devices. The ultrasonic receivers may be respectively connected with the demodulation and time comparison devices, can simultaneously receive the first range reference signals of different ultrasonic frequencies, and can transmit the first range reference signals to the demodulation and time comparison devices. The demodulation and time comparison devices can be used respectively to demodulate the first range reference signals of different ultrasonic frequencies, and determine whether the communication distance between the slave communication module and the signal transmission source satisfies the predetermined range based on the time difference of the first range reference signals of different frequencies reaching the measurement unit. If so, the information about the source of the signals contained in the first range reference signals may be transmitted to the second control unit.

Advantageously, providing a scheme to determine the communication distance between the source of the signal transmission and the slave communication module through an ultrasonic signal, thereby determining the communication distance. Using ultrasonic waves, the communication distance can be calculated using the physical quantity of the traveling time of the ultrasonic signals. The transmission speed of ultrasonic waves is relatively slow, and the ultrasonic communication distance can be calculated by comparing the time difference between the sending and the receiving. Using at least three ultrasonic transmitters to simultaneously transmit ultrasonic signals of different frequencies, and modulating the information about the host module into the ultrasonic waves through methods such as OOK or FSK, the slave module receives the at least three ultrasonic signals, and the communication distance between the host module and the slave module can be calculated through comparison of the time difference of the at least three ultrasonic signals reaching the destination.

In some embodiments, the first range reference signal is an ultrasonic signal, and accurate communication distance control can be achieved using ultrasonic signals. The controllable range of communications can reach a few meters or a larger distance. Precise control of the communication may also be realized within the range of 1 m, 0.5 m, or even 10 cm. The ultrasonic approaches can be adopted in real-time, high-speed exchange of data among desktop electronic devices, as well as real-time, high-speed data exchange between vehicles, and between vehicles and card readers. The interference between the ultrasonic signals and the communication signals of the second wireless communication unit can be small.

In some embodiments, the second wireless communication unit is a Wi-Fi module, a Bluetooth module, or an UWB module. The data exchange and communication between the host communication module and other communication devices can be in various forms to satisfy various communication needs.

In some embodiments, the wireless communication frequency bands of the second wireless communications unit may be, for example, 433 MHz, 900 MHz, 2.4 GHz, 5.8 GHz, or 60 GHz. High-speed communication and data exchange can be realized using these frequency bands.

In some embodiments, the transmission of the first range reference signal of the reference unit is not carried out simultaneously with the quick establishment of the wireless communication and the data exchange. For example, the transmission of the first range reference signal and the establishment of the communication connection and the data exchange may be carried out separately, such as by stopping transmission of the first range reference signal when a communication connection is established and the data exchange is performed. As such, the transmission of the first range reference signal does not have to be carried out all the time, thus preventing the signals from interfering with each other, and improving the transmission efficiency and measurement accuracy.

In some embodiments, the reference unit sends the first range reference signal before the second wireless communication unit quickly establishes the wireless communication connection according to a predetermined protocol and performs data exchange.

In some embodiments, the measurement unit intermittently receives the first range reference signals, and the second wireless communication unit performs fast data exchange between the receptions of the first range reference signals.

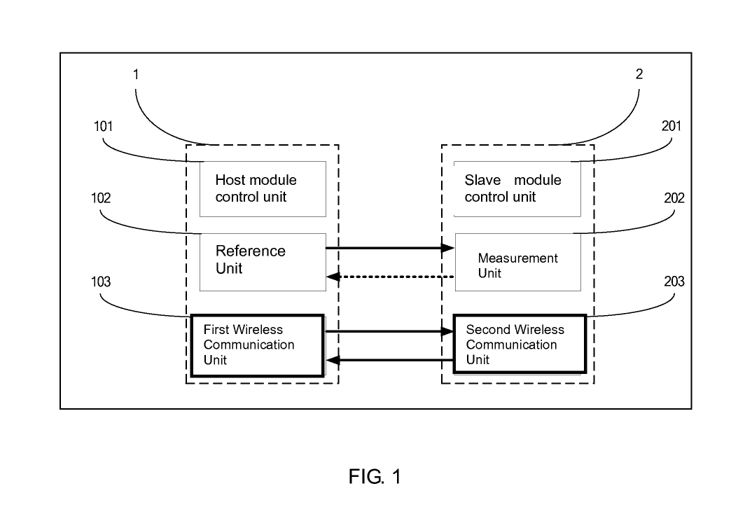

FIG. 1 is a schematic diagram illustrating a system of the fast access, highly efficient short-range wireless communication with a controllable communication range. The system may comprise the host communication module and the slave communication module. The host communication module can transmit the first range reference signal containing the host communication module information and the communication distance information. The slave communication module can determine whether the communication distance between the host communication module 1 and the slave communication module 2 meets a predetermined range according to the information contained in the first range reference signal. If so, the host communication module 1 and the slave communication module 2 quickly establish a wireless communication connection and exchange data according to a predetermined protocol.

The rate at which the host communication module 1 and the slave communication module 2 establish the fast wireless communication connection and exchange data may be higher than the rate at which the host communication module 1 sends the first range reference signal.

As shown in FIG. 1, the host communication module 1 includes a reference unit 102, a first wireless communication unit 103, and a first (host module) control unit 101 that controls the wok of the reference unit 102 and the first wireless communication unit 103. The slave communication module 2 includes a measurement unit 202, a second wireless communication unit 203, and a second (slave module) control unit 201 that controls the work of the measurement unit 202 and the second wireless communication unit 203.

A forward communication channel may be formed from the reference unit 102 to the measurement unit 202. In some embodiments, a reverse communication channel from the measurement unit 202 to the reference unit 102 may also be present. Between the first wireless communication unit 103 and the second wireless communication unit 203, a two-way high-speed wireless communication channel may be formed. The reference unit 102 can send the first range reference signal to the measurement unit 202 through the forward communication channel. In some embodiments, the measurement unit 202 can also be used to send the second range reference signal to the reference unit 102 via the reverse communication channel.

The measurement unit 202 can receive the first range reference signal sent by the reference unit 102, and determine whether the distance between the host communication module 1 and the slave communication module 2 satisfies a predetermined range. If so, the information about the host communication module contained in the first range reference signal may be transmitted to the second control unit 201. After receiving the information about the host communication module, through the first wireless communication unit 103 and the second wireless communication unit 203, the second control unit 201 quickly establishes wireless communication between the host communication module 1 and the slave communication module 2 according to the predetermined protocol, and performs exchange of data.

In some embodiments, the measurement unit 202 and the reference unit 102 also may have the functions of the above-mentioned reference unit 102 and the measurement unit 202, respectively. In some embodiments, the measurement unit 202 can send the second range reference signal to the reference unit 102 through the reverse communication channel. Accordingly, the first control unit 101 and the second control unit 201 can have control functions of each other in order to measure the distance between the host communication module 1 and the slave communication module 2. The first wireless communication unit 103 and the second wireless communication unit 203 conduct wireless communications under the control of the first control unit 101 and the second control unit 201, respectively.

In some embodiments, the first wireless communication unit 103 and the second wireless communication unit 203 may comprise a 2.4 GHz frequency band Wi-Fi module, a Bluetooth module, or a UWB module. Other frequencies can also be used, such as 433 MHz, 900 MHz, 5.8 GHz, and 60 GHz.

High-speed wireless communication unit access parameters between the first wireless communication unit 103 and the second wireless communication unit 203 may include, for example, the access channel, the Service Set Identifier (SSID) of the host communication module 1, the physical address of the host communication module 1, a cipher key, or a certificate, etc. These parameters can be issued from the reference unit 102 of the host communication module 1, and received by the measurement unit 202 of the slave communication module 2 within the predetermined range (e.g., 1 meter). The slave communication module 2 can analyze these parameters, and set the relevant parameters to connect with the host communication module 1. After the connection is established, mutual authentication through the cipher key or the certificate may be performed to determine whether to perform the subsequent data exchange.

The communication between the reference unit 102 and the measurement unit 202 can use magnetic signals in some embodiments, or ultrasonic signals in some other embodiments.

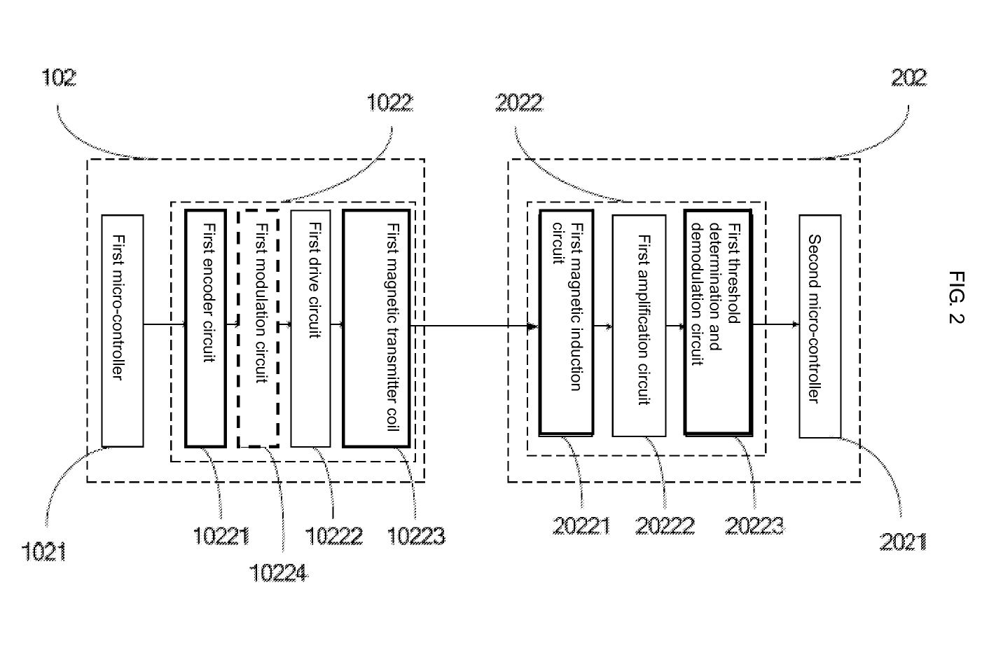

As shown in FIG. 2, the reference unit 102 may be a magnetic signal reference unit, the measurement unit 202 may be a magnetic signal measuring unit, and the first range reference signal sent by the reference unit 102 to the measurement unit 202 may be in the form of a magnetic signal. In some embodiments, the reference unit 102 includes serially-connected a first micro-controller 1021, a first encoder circuit 10221, a first drive circuit 10222, and a first magnetic field transmitter coil 10223. The first micro-controller 1021 can control the first encoder circuit 10221 and the first drive circuit 10222. The first encoder circuit 10221, the first drive circuit 10222, and the first magnetic field transmitter coil 10223 can form the forward transmission unit 1022, which can transmit the first range reference signal in the form of a magnetic signal.

The measurement unit 202 may include serially-connected a first magnetic induction circuit 20221, a first amplification circuit 20222, a first threshold determination and demodulation circuit 20223, and a second micro-controller 2021. The second micro-controller 2021 can control the first magnetic induction circuit 20221, the first amplification circuit 20222, and the first threshold determination and demodulation circuit 20223. The first magnetic induction circuit 20221, the first amplification circuit 20222, the first threshold determination and demodulation circuit 20223 can form a forward reception and determination unit 2022. The forward reception and determination unit 2022 can receive magnetic signals and determine whether the distance between the host communication module 1 and the slave communication module 2 satisfies a predetermined range. If so, the information about the host communication module contained in the first range reference signal may be transmitted to the second micro-controller 2021, and the second micro-controller 2021 may transmit the information about the host communication module to the second control unit 201.

In some embodiments, the first encoder circuit 10221 in the forward transmission unit 1022 can encode the wireless data frame of the information about the host communication module bit by bit and transmit it to the first drive circuit 10222. The first drive circuit 10222 can drive the first magnetic field transmitter coil 10223 to produce a low frequency alternating magnetic field. The first magnetic field transmitter coil 10223 can generate the first range reference signal containing the host communication module information, and send it to the slave communication module 2 in the form of a magnetic signal.

The first magnetic sensing circuit 20221 in the forward reception and determination unit 2022 can sense and receive the first range reference signal in the form of a magnetic signal sent by the host communication module, and convert it into an electronic signal. The first amplification circuit 20222 can amplify the first range reference signal in the form of the electronic signal. The first threshold determination and demodulation circuit 20223 can determine whether the first range reference signal in the form of the electronic signal has reached the predetermined threshold value (e.g., a threshold voltage value). If so, the information about the host communication module in the first range reference signal may be transmitted to the second microcontroller 2021.

In some embodiments, within the forward transmission unit 1022, a first modulation circuit 10224 can be provided between the first encoder circuit 10221 and the first drive circuit 10222, and can modulate the information about the host communication module after it has been encoded by the first encoder circuit 10221 and transmit it to the first drive circuit 10222.

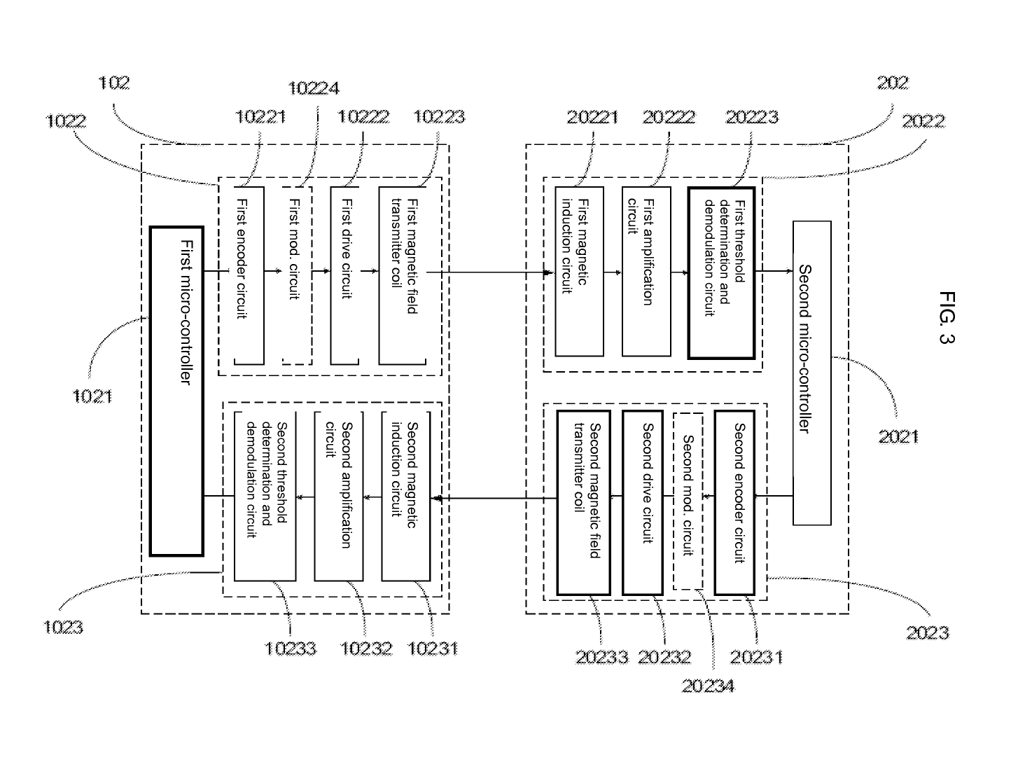

In some embodiments, from the one-way communication between the reference unit 102 and the measurement unit 202 as shown in FIG. 2, the system can be expanded to achieve bidirectional communications between the reference unit 102 and the measurement unit 202, as illustrated in FIG. 3.

The measurement unit 202 may further comprise a second encoder circuit 20231, a second drive circuit 20232, and a second magnetic field transmitter coil 20233. The second micro-controller 2021, the second encoder circuit 20231, the second driver circuit 20232, and the second magnetic field transmitter coil 20233 may be serially connected. The second micro-controller 2021 can control the second encoder circuit 20231 and the second drive circuit 20232.

The reverse transmission unit 2023 may comprise the second encoder circuit 20231, the second drive circuit 20232, and the second magnetic field transmitter coil 20233, and can send the second range reference signal in the form of a magnetic signal containing the communication distance information about the host communication module and the slave communication module. Correspondingly, the reference unit 102 may also include a second magnetic induction circuit 10231, a second amplification circuit 10232, and a second threshold determination and demodulation circuit 10233, which may be serially connected together with the first micro-controller 1021. The first micro-controller 1021 can control the second magnetic induction circuit 10231, the second amplification circuit 10232, and the second threshold determination and demodulation circuit 10233.

The reverse reception and determination unit 1023 may comprise the second magnetic induction circuit 10231, the second amplification circuit 10232, and the second threshold determination and demodulation circuit 10233. The reverse reception and determination unit 1023 can receive the second range reference signal in the form of a magnetic signal, and determine whether the distance between the slave communication module 2 and the host communication module 1 satisfies a predetermined range. If so, the information about the slave communication module contained in the second range reference signal may be transmitted to the first micro-controller 1021, which may send the information about the slave communication module to the first control unit 101. After receiving the information about the slave communication module, through the first wireless communication unit 103 and the second wireless communication unit 203, the first control unit 101 quickly establishes the wireless communication connection between the host communication module 1 and the slave communication module 2 and performs data exchange according to a predetermined protocol.

As shown in FIG. 3, the second encoder circuit 20231 in the reverse transmission unit 2023 can encode the wireless data frame of the host communication module information bit by bit and transmit it to the second drive circuit 20232. The second drive circuit 20232 can drive the second magnetic field transmitter coil 20233 and generate a second low-frequency alternating magnetic field. The second magnetic field transmitter coil 20233 can generate the second range reference signal containing the information about the slave communication module and send it to host communication module 1 in the form of a magnetic signal.

The second magnetic induction circuit 10231 in the reverse reception and determination unit 1023 can sense and receive the second range reference signal in the form of a magnetic signal sent by the slave communication module 2, and convert it into an electrical signal. The second amplification circuit 10232 can amplify the second range reference signal in the form of the electrical signal. The second threshold determination and demodulation circuit 10233 can determine whether the second range reference signal in the form of the electrical signal reaches the predetermined threshold. If so, the information about the slave communication module contained in the second range reference signal may be transmitted to the first micro-controller 1021.

In some embodiments, in the reverse transmission unit 2023, a second modulation circuit 20234 can be provided between the second encoder circuit 20231 and the second drive circuit 20232, and can modulate the information about the slave communication module after it is encoded by the second encoder circuit 20231 and send it to the second drive circuit 20232.

In some embodiments, the magnetic induction circuit can comprise a Printed Circuit Board (PCB) coil, an enameled wire coil, a Hall device, or other devices that can sense the change of the magnetic field. The threshold determination and demodulation circuit can determine the magnetic detection voltage signal in accordance with a predetermined distance threshold. If it has not reached the threshold, demodulation is not performed and communication is not allowed. If it has reached the threshold, the signal is demodulated, and the demodulated signal is transmitted to the second micro-controller.

In some embodiments, the reference unit 102 and the measurement unit 202 may be low-frequency magnetic induction communication circuits. Their working frequencies may be selected from, for example, 500 Hz, 1 kHz, 1.5 kHz, 2 kHz, 2.5 kHz, 3 kHz, 4 kHz, 5 kHz, 10 kHz, 20 kHz, 30 kHz, or 10 MHz. The good penetration characteristics of the low-frequency alternating magnetic fields can be utilized to conduct controllable communications within the predetermined range.

The circuits of the forward reception and determination unit 2022 may comprise a PCB coil, an enameled wire coil, a Hall device, a giant magnetoresistance, or a magnetic induction switch, etc. Any other sensors that can transform a magnetic field variation into an electrical signal may also be adopted for the module.

In some embodiments, a low-frequency alternating magnetic field is used to achieve a controllable communication distance, and a high-speed wireless communication channel in conjunction with the reference unit 102 and the measurement unit 202 is used to achieve reliable and fast connection between the host communication module 1 and the slave communication module 2.

In some embodiments, the high-speed wireless communication channel between the first wireless communication unit 103 and the second wireless communication unit 203 allows the high-speed data communication between the host communication module 1 and slave communication module 2. The reference unit 102 of the host communication module transmits a low-frequency alternating magnetic field signal. The slave communication module 2 only needs to receive the magnetic field signal, therefore the receiver coil or other types of receiver circuits can be miniaturized for implementation into compact mobile devices. Because the received signal may be relatively weak, the amplification circuit may be included in the mobile device. In addition, the second wireless communication unit 203 disposed in the mobile device may be a high-speed wireless communication unit (e.g., Wi-Fi, Bluetooth, etc.) in order to achieve a bidirectional high speed communication.

The antenna of the reference unit 102 on the host communication module 1 and the antenna of the measurement unit 202 on the slave communication module 2 can be very small, and thus can be easily integrated into the mobile device.

In some embodiments, distance control is more accurate if the system works at below the selected frequency (e.g., 500 Hz, 1 kHz, 1.5 kHz, 2 kHz, 2.5 kHz, 3 kHz, 4 kHz, 5 kHz, 10 kHz, 20 kHz, 30 kHz, or 10 MHz). In some other embodiments, the system may work above these frequency points, with a reduced distance control accuracy.

In some embodiments, distance determination may be achieved through a predetermined threshold value. For example, the host communication module transmits a low frequency magnetic signal according to predetermined transmission parameters. The slave communication module 2 receives the low frequency signal, and converts it into a voltage signal. Whether the distance between the slave communication module 2 and the host communication module 1 has entered a valid predetermined range may be determined through the predetermined threshold voltage value. The threshold value may be the same for all slave communication modules 2. As such, it is not necessary to modify the threshold value for different slave communication modules, and it is not necessary to perform calibrations for various mobile devices.

In various embodiments, the first modulation circuit 10224 or the second modulation circuit 20234 can use multiple modes of modulations. In some embodiments, carrier modulation may be adopted. The baseband signal generated by the first encoder circuit 10221 or the second encoder circuit 20231, through the first modulation circuit 10224 or the second modulation circuit 20234, modulates the carrier. The carrier may be a sine wave, a square wave, or a triangular wave, etc. On-off keying (OOK), phase shift keying, frequency shift keying (FSK), etc. can be used for modulation. The modulated signal may be loaded into the first magnetic field transmitter coil 10223 or the second magnetic field transmitter coil 20233 through the first drive circuit 10222 or the second drive circuit 20232.

In some embodiments, no-carrier direct baseband transmission may be adopted. For example, baseband signals generated by the first encoder circuit 10221 or the second encoder circuit 20231 may be directly loaded into the first magnetic field transmitter coil 10223 or the second magnetic field transmitter coil 20233 through the first drive circuit 10222 or the second drive circuit 20232.

In some embodiments, other modulation methods may be adopted. Because the threshold value determination is used to control range according to some embodiments, any modulation methods that can keep the amplitudes of testing signals in the slave communication module substantially constant can be used.

In various embodiments, the first encoder circuit 10221 or the second encoder circuit 20231 can use a variety of encoding methods. For example, Manchester encoding may be adopted, where bit 1 is encoded as two symbols 01, and bit 0 is encoded as 10. In another example, differential Manchester encoding may be adopted, where there are two kinds of bit symbol sequences: 01 and 10. Bit 1 may be used when it belongs to symbol series different from the last symbol. On the other hand, bit 0 may be used when the situation is the opposite. Encoding the other way around is also possible.

Other encoding methods may also be adopted. The low-frequency modulation signal may be maintained with a stable mean. For example, the encoded sequence does not contain a DC component, and various encoding methods where the average DC component is zero can be used.

In some embodiments, the first magnetic field transmitter coil 10223 or the second magnetic field transmitter coil 20233 may comprise an enameled wire coil or a PCB coil. The number of turns of the first magnetic field transmitter coil 10223 or the second magnetic field transmitter coil 20233 may be greater than 10, such as 50-500. The first magnetic field transmitter coil 10223 or the second magnetic field transmitter coil 20233 may be stuffed with a ferrite core or an iron core. In some embodiments, the cross-section of the area surrounded by the first magnetic field transmitter coil 10223 or the second magnetic field transmitter coil 20233 includes at least a circular area with a diameter of 3 cm, or a square area of 3 cm×3 cm.

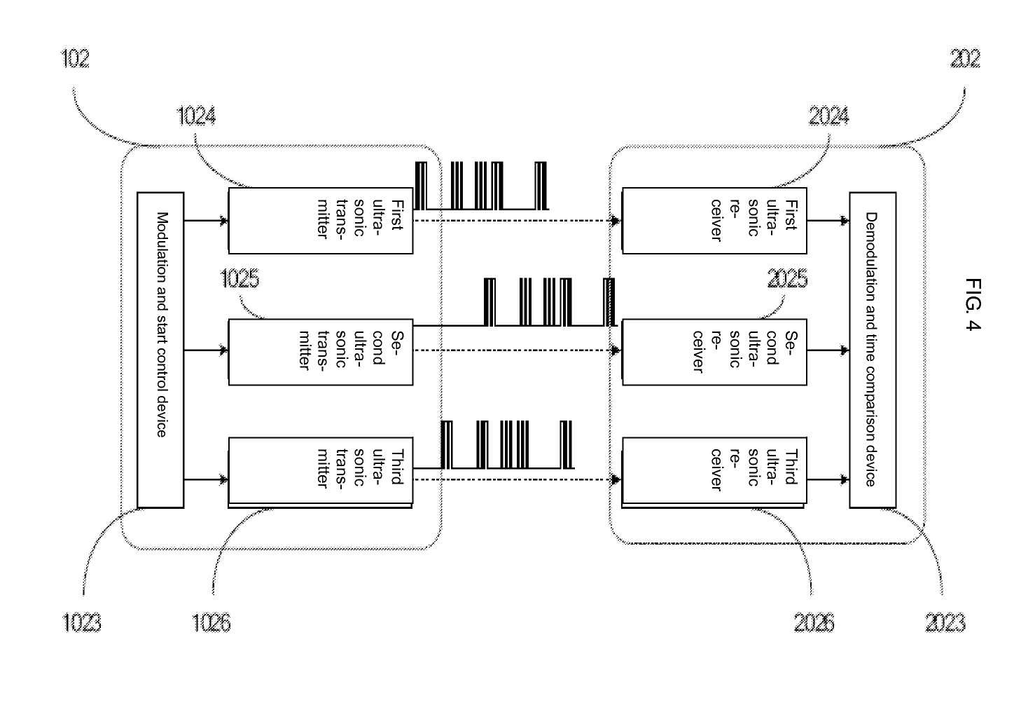

In some other embodiments, as shown in FIG. 4, ultrasonic signals may be adopted. The reference unit 102 may include a modulation and start control device 1023, a first ultrasonic transmitter 1024, a second ultrasonic transmitter 1025, and a third ultrasonic transmitter 1026. The modulation and start control device 1023 may be connected with the first ultrasonic transmitter 1024, the second ultrasonic transmitter 1025, and the third ultrasonic transmitter 1026. The modulation and start control device 1023 can modulate the information about the host communication module into the first range reference signal, and simultaneously start the first ultrasonic transmitter 1024, the second ultrasonic transmitter 1025, and the third ultrasonic transmitter 1026 in order to send the range reference signal in the form of ultrasonic waves.

The first ultrasonic transmitter 1024, the second ultrasonic transmitter 1025, and the third ultrasonic transmitter 1026 can transmit ultrasonic signals of different frequencies. Measurement unit 202 includes a demodulation and time comparison device 2023, a first ultrasonic receiver 2024, a second ultrasonic receiver 2025, and a third ultrasonic receiver 2026. Demodulation and time comparison device 2023 is connected with the first ultrasonic receiver 2024, the second ultrasonic receiver 2025, and the third ultrasonic receiver 2026. The first ultrasonic receiver 2024, the second ultrasonic receiver 2025, and the third ultrasonic receiver 2026 can respectively receive the ultrasonic signals of different frequencies transmitted by the first ultrasonic transmitter 1024, the second ultrasonic transmitter 1025, and the third ultrasonic transmitter 1026, and transmit the received ultrasonic signals of different frequencies to the demodulation and time comparison device 2023. The demodulation and time comparison device 2023 can demodulate the ultrasonic signals of different frequencies and determine whether the distance between the host communication module 2 and the slave communication module 2 meets the predetermined range according to the time difference of the ultrasonic signals of different frequencies reaching the measurement unit 202. If so, then the information about the host communication module contained in the first range reference signal may be transmitted to the second control unit 201.

In some embodiments, the modulation and the start control device 1023 can modulate the information about the host communication module into the first range reference signal in the form of ultrasonic waves through the OOK method. The first ultrasonic receiver 2024, the second ultrasonic receiver 2025, and the third ultrasonic receiver 2026 only receive corresponding first range reference signals transmitted by the first ultrasonic transmitter 1024, the second ultrasonic transmitter 1025 and the third ultrasonic transmitter 1026, respectively. For example, the first ultrasonic receiver 2024 only receives the signals of the first ultrasonic transmitter 1024, the second ultrasonic receiver 2025 only receives the signal of the second ultrasonic transmitter 1025, and the third ultrasonic receiver 1026 only receives the signal of the third ultrasonic transmitter 1026.

In some embodiments, the reference unit 102 may employ a plurality of modulation and start control devices, and three or more ultrasonic transmitters, and the corresponding measurement unit 202 may also employ a plurality of demodulation and time comparison devices, and three or more ultrasonic receivers. In a preferred embodiment, one modulation and start control device, three ultrasonic transmitters, one demodulation and time comparison device, and three ultrasonic receivers are employed.

In a communication system according to some embodiments, the host communication module 1 transmits the information about the host communication module to the slave communication module 2 through low-frequency magnetic signals or ultrasonic signals. The slave communication module 2 sends the information about the host communication module back to the host communication module 1 through the two-way high-speed wireless communication channel of the second wireless communication unit 203 and the first wireless communication unit 103. Through determining the correctness of the information about the host communication module 1 that was sent back, the unique binding between the host communication module 1 and the slave communication module 2 can be achieved.

After the binding, the bi-directional high-speed wireless communication of large amount of data between the host communication module 1 and the slave communication module 2 can be accomplished through the bi-directional high-speed wireless communication channel between the first wireless communication unit 103 and the second wireless communication unit 203.

In some embodiments, the transmission of the first range reference signal is not conducted simultaneously with the quick establishment of the wireless communication connection and the data exchange. For example, the transmission of the first range reference signal may be prior to the fast establishment of the wireless communication connection and the data exchange.

In some other embodiments, the host communication module intermittently transmits the first range reference signals. The host communication module 1 and the slave communication module 2 perform fast data exchange at the intervals of the transmission of the first range reference signals.

If the slave communication module 2 determines, based on the first range reference signal, that the distance between the host communication module and the slave communication module satisfies the predetermined range, then before the host communication module 1 and the slave communication module 2 establish the wireless connection and exchange data according to a predetermined protocol, the host communication module 1 and the slave communication module 2 can cut off the transmission of the first range reference signals between them to prevent signal interference. As such, the transmission efficiency and measurement accuracy can be improved.

In some embodiments, the slave communication module 2 sends a confirmation signal to the host communication module 1, the host communication module stops sending the first range reference signals according to the confirmation signal received, then the host communication module 1 and the slave communication module 2 quickly establish a wireless communication connection and exchange data according to a predetermined protocol.

In some other embodiments, the slave communication module first stops receiving the first range reference signals, then the host communication module 1 and the slave communication module 2 quickly establish the wireless communication connection and exchange according to a predetermined protocol.

The host communication module 1 and the slave communication module 2 can be placed separately in different host machines. As such, the information for host communication module 1 can also be the information for the host machine, thereby enabling fast access, short range wireless communications with a controllable communication range among a variety of host machines.

The host machines may include, but not limited to, smart terminals and/or smart transportation tools. For example, the smart terminals may include desktop computers, notebook computers, tablet PCs, PDAs, mobile phones, digital cameras, digital video cameras, e-readers, audio and video playback devices, and digital photo frames, etc. The smart transportation tools may include smart cars, or cars, trains, airplanes, ships, or other transportation tools that provide data exchange functions.

A system for fast access short range wireless communication with a controllable communication range may be provided including at least one host module and at least one slave module. Advantages of one or more embodiments disclosed herein may include, but are not limited to: the system realizes real-time, fast, efficient wireless communication and data exchange within a predetermined range. Using the communication distance information as a necessary condition for access according to some embodiments enables real-time, fast and efficient wireless communications between the host module and the slave module and data exchange, as long as the slave device satisfies the predetermined communication range. As such, it greatly simplifies the processes of pre-configuration between the host devices and slave devices in communication technologies such as Wi-Fi, Bluetooth, etc., Issues in communication technologies such as addressing, handshake authentication, complex exchange protocol overhead, etc. may also be simplified according to some of the embodiments.

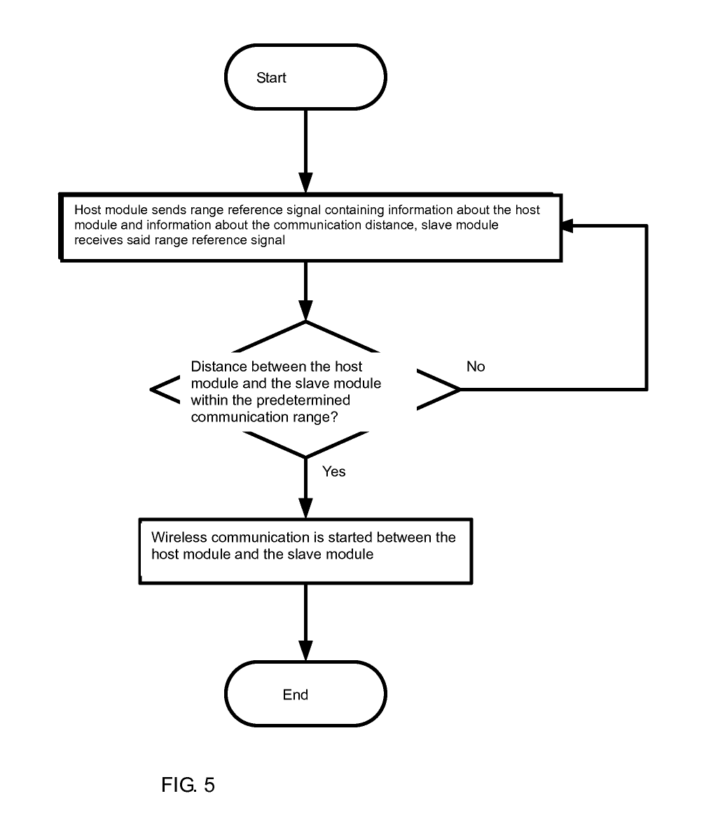

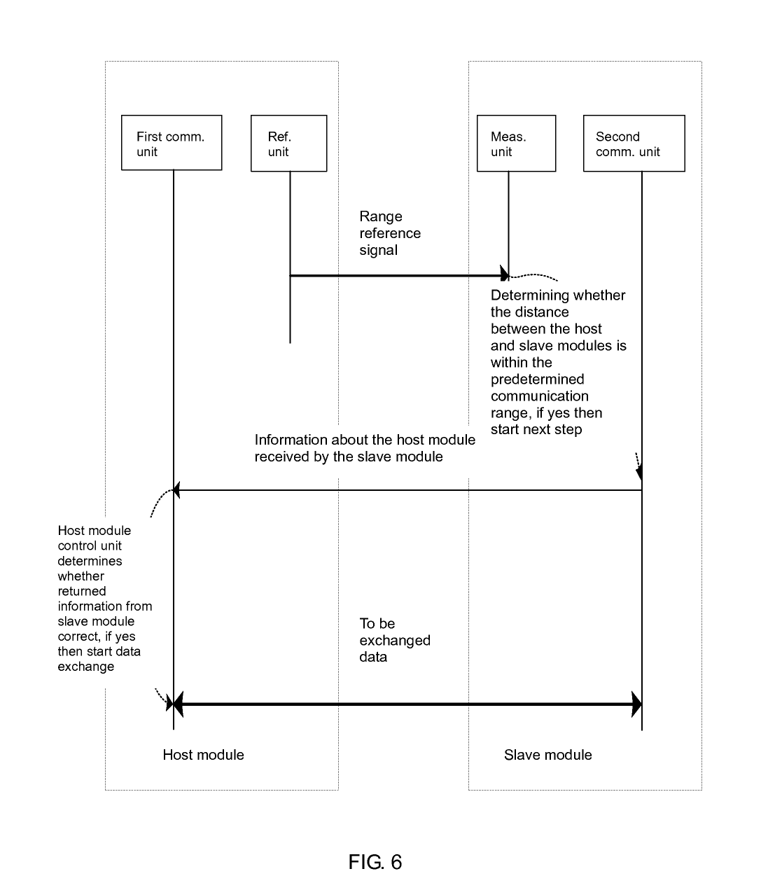

Some embodiments provide a method for fast access wireless communication with a controllable communication range. An example method may include the following steps, as illustrated in FIGS. 5 and 6.

Step A: the host module transmits the range reference signal, the slave module receives the range reference signal and executes step B.

Step B: determining whether the distance between the slave module and the host module satisfies a predetermined range. If so, executing step C; otherwise, executing step A.

Step C: the wireless communication between the host module and the slave module is established and data exchange is performed.

The above method for fast access short range wireless communication with a controllable communication range realizes real-time, fast, efficient wireless data exchange within a predetermined range between the host module and the slave module, thereby realizing real-time, fast, efficient wireless data exchange within a predetermined range between the host machines having host modules or slave modules disposed therein. It greatly simplifies the processes of pre-configuration between the host devices and slave devices in communication technologies such as Wi-Fi, Bluetooth, as well as issues such as addressing, handshake authentication, complex exchange protocol overhead, etc. in communication technologies.

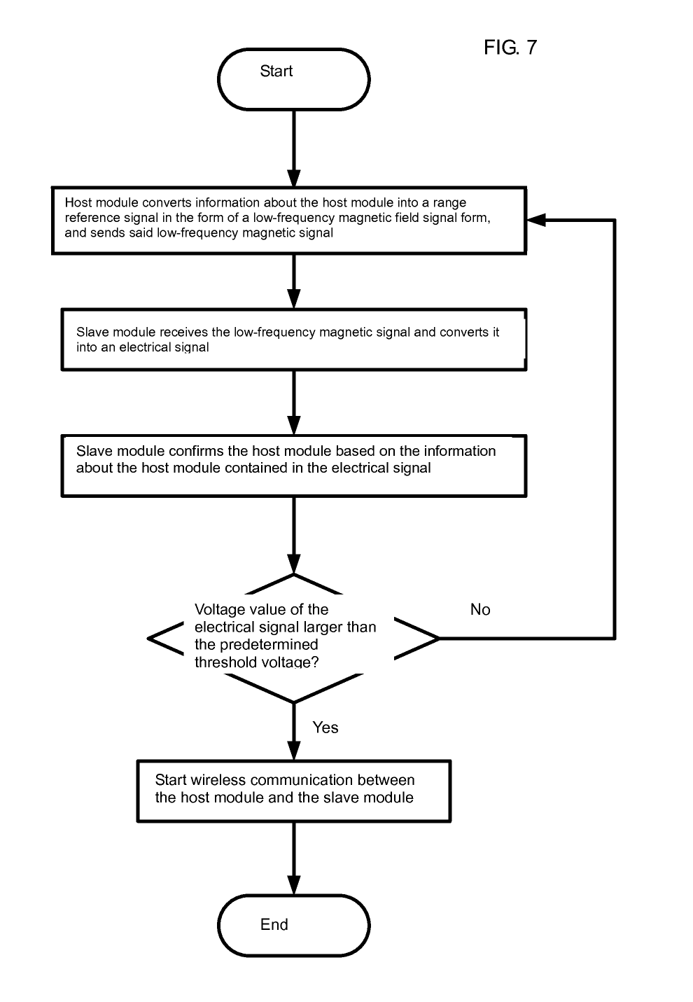

In some embodiments where magnetic signals are adopted, as illustrated in FIG. 7, Step A may comprise Step A1: the host module converts the information about the host module into a range reference signal in the form of a low-frequency magnetic signal, transmits the low-frequency magnetic signal, and executes step A2; and Step A2: the slave module receives the low-frequency magnetic signal and converts it into an electrical signal, and executes step B.

In some embodiments, Step B comprises Step B1: the slave module determines the host module according to the information about the host module contained in the electrical signal; and Step B2: the slave module determines the threshold value of the electrical signal, and if the voltage value of the electrical signal is greater than or equal to the predetermined threshold value, then executes step C; otherwise, executes step A1.

Because the range reference signal contains the information about the host module and the information about the communication distance, the method facilitates the slave module to determine the host module and determine the distance.

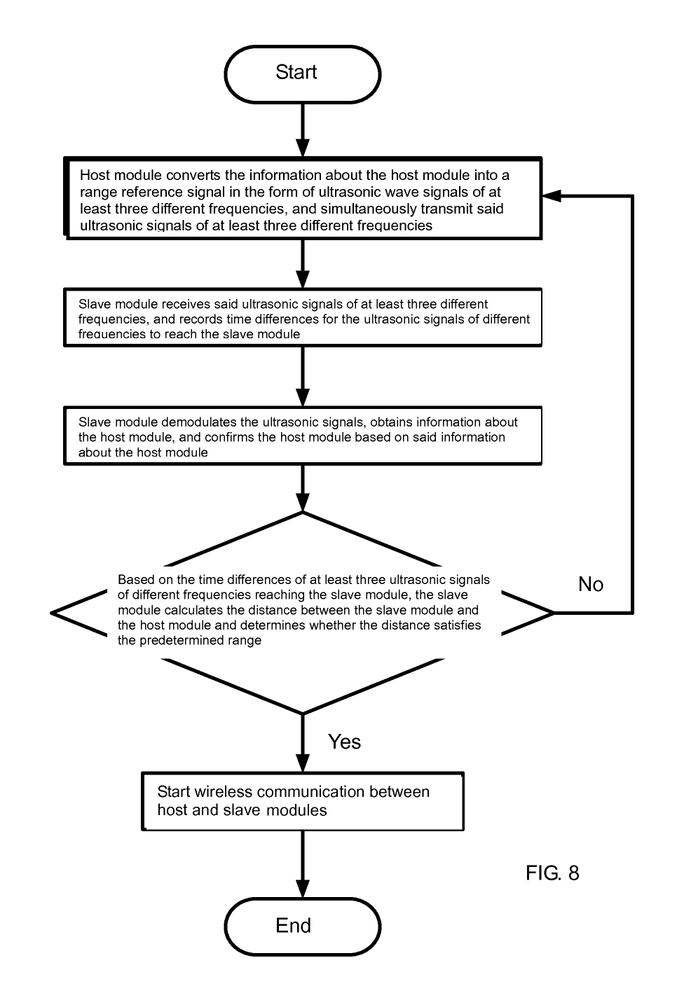

In some other embodiments where ultrasonic signals are adopted, as illustrated in FIG. 8, Step A may comprise Step A1′: the host module converts the information about host module into range reference signals in the form of ultrasonic signals of at least three different frequencies, simultaneously transmits the ultrasonic signals of at least three different frequencies, and executes step A2′; and Step A2′: the slave module receives the ultrasonic signals of at least three different frequencies, records the time difference of the ultrasonic signals of different frequencies reaching the slave module, and executes step B.

In these embodiments, Step B may comprise Step B1′: the slave module demodulates the ultrasonic signals, obtains the information about the host module, and confirms the host module according to the information about the host module; and Step B2′: the slave module calculates the distance between the slave module and the host module, and determines whether the distance satisfies a predetermined range according to the time difference of the at least three ultrasonic signals of different frequencies reaching the slave module, and if yes, executes step C; otherwise, executes step A1′.

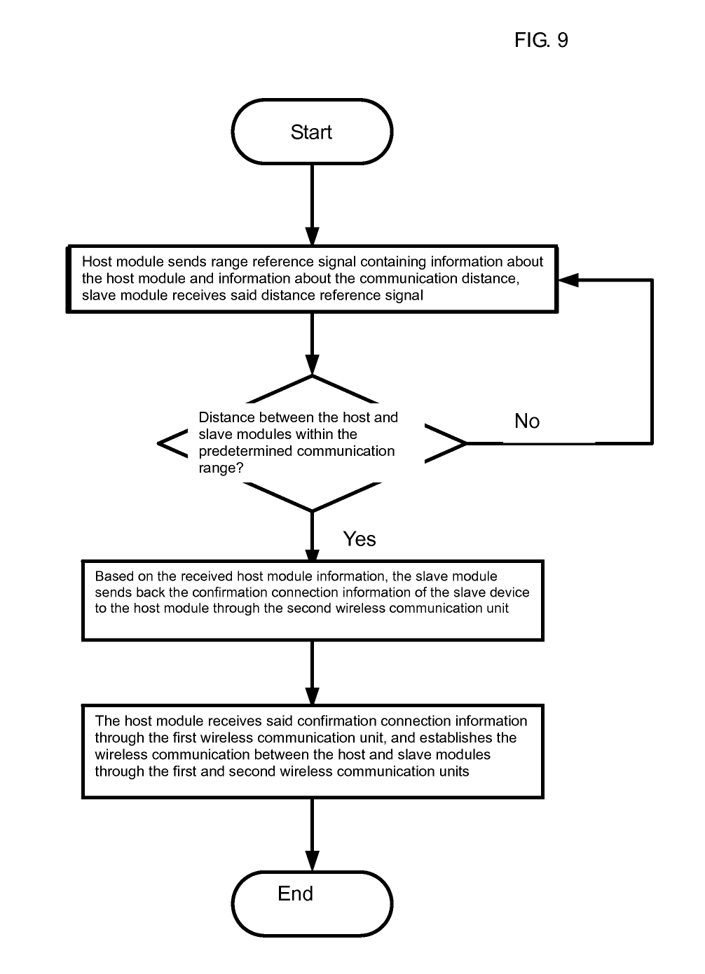

In some embodiments, as illustrated in FIG. 9, Step C may comprise Step C1: the slave module sends the access confirmation message of the slave module back to the host module via the second wireless communication unit according to the information about the host module received; and Step C2: the host module receives the access confirmation message via the first wireless communication unit, and establishes wireless communication between the host module and the slave module through the first wireless communication unit and the second wireless communication unit.

Some advantages of at least some of the embodiments may include, using access confirmation between the host module and the slave module to allow the start of the wireless communication may improve the security of the communication; when the host module receives the access confirmation message containing the information about the host module, through the information about the host module, it can determine that the slave module is the slave module that receives the range reference signal sent by the host module and determines that the communication distance is within the predetermined communication range, and thus determines the uniqueness of the slave module, thereby preventing the slave module from being counterfeited, and guaranteeing the security of communication between the host module and the slave module.

In some of the embodiments, the transmission of the wireless range reference signal is not carried out simultaneously with the quick establishment of wireless communication and the performance of data exchange. For example, the transmission of the range reference signal can be carried out before the establishment of high-speed wireless communication and the data exchange between the host module and the slave module. In another example, the host module may transmit range reference signals intermittently, and the host module and the slave module perform fast data exchanges at the intervals of the transmission of range reference signals. After the slave module satisfies the predetermined range, the transmission of range reference signals between the host module and the slave module may be cut off first, and the establishment of high-speed wireless communication and the performance of data exchange between the host module and the slave module may be carried out.

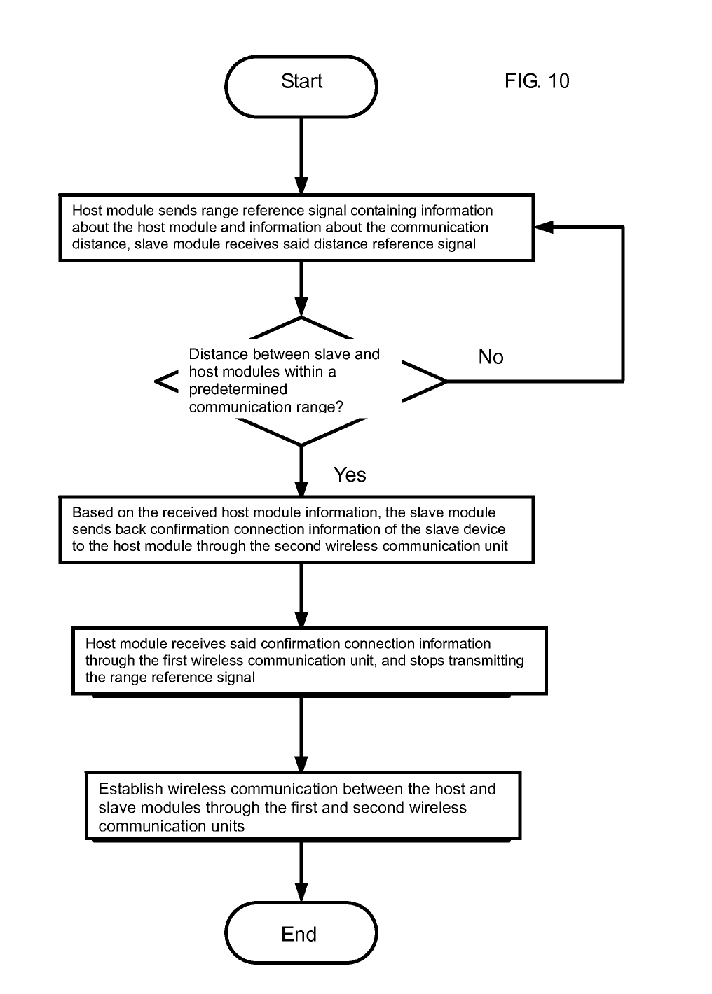

In some embodiments, as illustrated in FIG. 10, Step C may comprises Step C1′: the slave module sends back the access confirmation message of the slave module to the host module via the second wireless communication unit according to the information about the host module received; Step C2′: the host module receives the access confirmation message through the first wireless communication unit and stops transmitting the range reference signal; and Step C3′: establishing wireless communication between the host module and the slave module through the first wireless communication unit and the second wireless communication unit. The access confirmation message may contain information about the host module, and the range reference signal may contain information about the host module and information about communication distance.

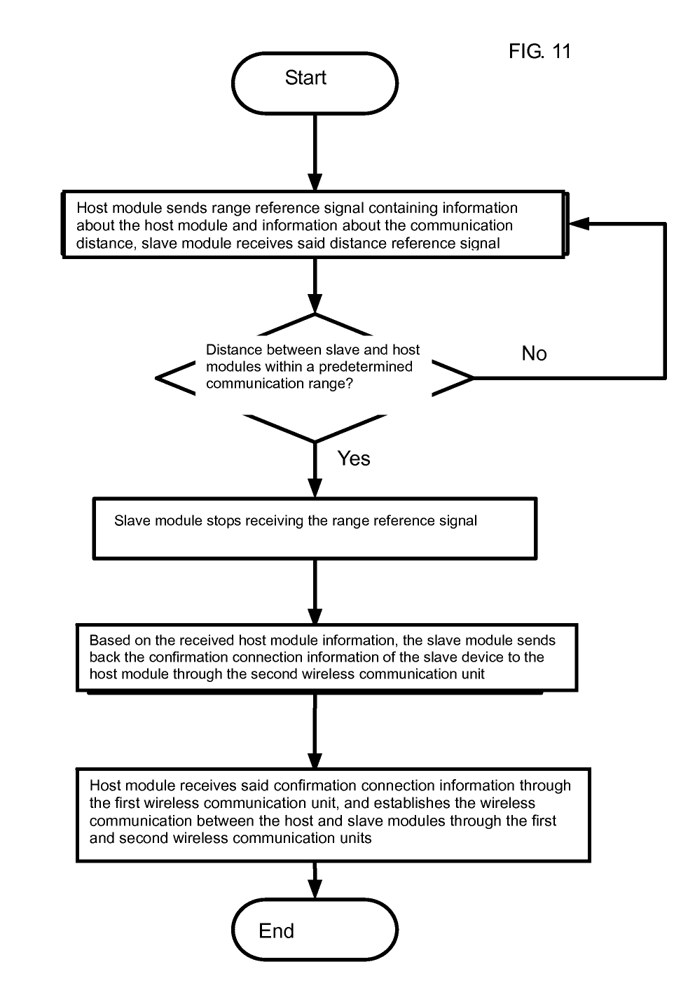

In some other embodiments, as illustrated in FIG. 11, Step C may comprise Step C1″: the slave module stops receiving the range reference signal; Step C2′: the slave module sends access confirmation message of the slave module back to the host module via the second wireless communication unit according to the information about the host module received; and Step C3″: the host module receives the access confirmation message via the first wireless communication unit, and establishes wireless communication between the host module and the slave module via the first wireless communication unit and the second wireless communication unit. The access confirmation message contains information about the host module.

As such, before the establishment of the wireless communication connection and performance of data exchange and after the distance determination between the host module and the slave module, the transmission and reception of the first range reference signal may be cut off to stop distance determination, thereby preventing the interference between signals, and improving transmission efficiency and measurement accuracy.

In some embodiments, the transmission of the first range reference signal by the host module, and the quick establishment of the wireless communication connection and performance of data exchange are not carried out simultaneously.

In some embodiments, the host module transmits the first range reference signal before the host module and the slave module quickly establish the wireless communication connection and perform data exchange according to a predetermined protocol.

In some embodiments, the host module intermittently transmits the first range reference signals, and the host module and slave module perform fast data exchange at the intervals of the transmissions of first range reference signals.

At least some advantages of at least some of the embodiments may include, for example, signal interferences may be reduced, and transmission efficiency and measurement accuracy may be improved.

All references cited in the description are hereby incorporated by reference in their entirety. While the disclosure has been described with respect to a limited number of embodiments, those skilled in the art, having benefit of this disclosure, will appreciate that other embodiments can be advised and achieved which do not depart from the scope of the description as disclosed herein.

1. A communication device comprising:
a reference unit;
a first wireless communication unit; and
a first control unit configured to control the reference unit and the first wireless communication unit;
wherein the first wireless communication unit is configured to establish a wireless communication connection and perform data exchange according to a predetermined protocol; and
wherein the reference unit is configured to send a first range reference signal wirelessly to thereby control a communication range of the wireless communication connection.

2. The communication device of claim 1, wherein a rate at which the first wireless communication unit establishes the wireless communication connection and performs data exchange is higher than a rate at which the reference unit transmits the first range reference signal.

3. The communication device of claim 2, wherein the first range reference signal contains information about the communication device and information about the communication range.

4. The communication device of claim 3, wherein the first range reference signal comprises a low-frequency magnetic signal having a frequency selected from 500 Hz, 1 kHz, 1.5 kHz, 2 kHz, 2.5 kHz, 3 kHz, 4 kHz, 5 kHz, 10 kHz, 20 kHz, 30 kHz, or 10 MHz.

5. The communication device of claim 4, further comprising:
a first micro-controller;
a first encoder circuit;
a first drive circuit; and
a first magnetic field transmitter coil;
wherein the first micro-controller is configured to control the first encoder circuit and the first drive circuit;
wherein the first encoder circuit is configured to conduct bit-wise encoding of wireless data frame of the information about the communication device and transmit it to the first drive circuit;
wherein the first drive circuit is configured to drive the first magnetic field transmitter coil; and
wherein the first magnetic field transmitter coil is configured to generate the first range reference signal.

6. The communication device of claim 5, further comprising a first modulation circuit disposed between the first encoder circuit and the first drive circuit, wherein the first modulation circuit is configured to modulate the information about the communication device after it has been encoded by the first encoder circuit, and to transmit the information to the first drive circuit.

7. The communication device of claim 6, wherein the reference unit comprises:
a second magnetic induction circuit;
a second amplification circuit; and
a second threshold determination and demodulation circuit;
wherein the second magnetic induction circuit is configured to:
sense and receive a second range reference signal containing information about the source of the signal;
convert it into an electrical signal; and
transmit it to the second amplification circuit;
wherein the second amplification circuit is configured to amplify the second reference signal and transmit it to the second threshold determination and demodulation circuit;
wherein the second threshold determination and demodulation circuit is configured to determine whether the second range reference signal has reached a preset threshold value, if so, then the information about the source of the signal included in the second range reference signal is sent to the first micro-controller; and
wherein the first micro-controller is configured to:
control the second magnetic induction circuit, the second amplification circuit, the second threshold determination and demodulation circuit; and
transmit the received information about the source of the signal to the first control unit.

8. The communication device of claim 3, wherein the first range reference signal comprises an ultrasonic signal.

9. The communication device of claim 8, wherein the reference unit comprises:
at least three ultrasonic transmitters; and
at least one modulation and start control device coupled to the at least three ultrasonic transmitters;
wherein the modulation and start control device is configured to:
modulate the information about the communication device into the first range reference signal; and
start the at least three ultrasonic transmitters substantially simultaneously;
wherein the at least three ultrasonic transmitters are configured to separately transmit the first range reference signal in the form of ultrasonic waves of different frequencies.

10. The communication device of claim 1, wherein the first wireless communication unit is configured to operate at a frequency band selected from 433 MHz, 900 MHz, 2.4 GHz, 5.8 GHz, or 60 GHz, and wherein the data exchange is performed after the reference unit sends the first range reference signal, or at intervals of the transmission of the first range reference signal.

11. A communication system comprising:
a host communication device including:
a reference unit;
a first wireless communication unit; and
a first control unit configured to control the reference unit and the first wireless communication unit;
wherein the first wireless communication unit is configured to establish a wireless communication connection and perform data exchange according to a predetermined protocol; and
wherein the reference unit is configured to send a first range reference signal wirelessly to thereby control a communication range of the wireless communication connection; and
a slave communication device configured to determine whether a distance between the host communication device and the slave communication device satisfies a predetermined range according to the received first range reference signal, and if so, the host communication device and slave communication device quickly establish a wireless communication connection and exchange data according to a predetermined protocol.

12. The communication system of claim 11, wherein the slave communication device comprises:
a measurement unit;
a second wireless communication unit; and
a slave control unit configured to control the measurement unit and the second wireless communication unit;
wherein the measurement unit is configured to determine whether the distance satisfies the predetermined range according to the first range reference signal received from the reference unit, and if so, information about the host communication device contained in the first range reference signal is sent to the slave control unit; and
wherein the slave communication device is configured to, after receiving the information about the host communication device, through the first wireless communication unit and the second wireless communication unit, establish the wireless communication between the host communication device and the slave communication device, and perform data exchange according to the predetermined protocol.

13. The communication system of claim 12, wherein the measurement unit comprises:
a first magnetic induction circuit;
a first amplification circuit;
a first threshold determination and demodulation circuit; and
a second micro-controller;
wherein the first magnetic induction circuit is configured to:
sense and receive the first range reference signal in the form of a magnetic signal;
convert the magnetic signal into an electrical signal; and
transmit the electrical signal to the first amplification circuit;
wherein the first amplification circuit is configured to:
amplify the first range reference signal; and
transmit the amplified first range reference signal to the first threshold determination and demodulation circuit;
wherein the first threshold determination and demodulation circuit is configured to determine whether the first range reference signal reaches a predetermined threshold value, and if so, the information about the host communication device contained in the first range reference signal is transmitted to the second micro-controller; and
wherein the second micro-controller is configured to:
control the first magnetic induction circuit, the first amplification circuit, the first threshold determination and demodulation circuit; and
transmit the information about the host communication device to the slave communication device control unit.

14. The communication system of claim 13, wherein the measurement unit further comprises:
a second encoder circuit;
a second drive circuit; and
a second magnetic field transmitter coil;
wherein the second micro-controller is configured to control the second encoder circuit and the second drive circuit;
wherein the second encoder circuit is configured for bit-wise encoding of wireless data frame of information about the slave communication device and transmitting it to the second drive circuit;
wherein the second drive circuit is configured to drive the second magnetic field transmitter coil; and
wherein the second magnetic field transmitter coil is configured to generate the second range reference signal that contains the information about the slave communication device and transmit it in the form of a magnetic signal.

15. The communication system of claim 12, wherein the reference unit comprises:
at least three ultrasonic transmitters; and
at least one modulation and start control device coupled to the at least three ultrasonic transmitters;
wherein the modulation and start control device is configured to modulate the information about the host communication device into the first range reference signal, and start the at least three ultrasonic transmitters substantially simultaneously;
wherein the at least three ultrasonic transmitters are configured to transmit ultrasonic first range reference signals of different ultrasonic frequencies;
wherein the measurement unit comprises:
at least three ultrasonic receivers; and
at least one demodulation and time comparison device coupled to the at least three ultrasonic receivers;
wherein the at least three ultrasonic receivers are configured to:
receive ultrasonic first range reference signals of different ultrasonic frequencies respectively; and
transmit the first range reference signals to the demodulation and time comparison device;
wherein the demodulation and time comparison device is configured to:
demodulate the first range reference signals of different ultrasonic frequencies respectively; and
determine whether the communication distance satisfies the predetermined range based on time differences of the first range reference signals of different frequencies reaching the measurement unit, and if so, the information about the host communication device contained in the first range reference signals is transmitted to the slave control unit.

16. The communication system of claim 12, wherein the host communication device and the slave communication device are disposed respectively in different host apparatuses, wherein the host apparatuses are selected from desktop computers, notebook computers, tablet PCs, PDAs, mobile phones, digital cameras, digital video cameras, e-readers, audio and video playback devices, digital photo frames; or cars, trains, airplanes or ships that have interactive data exchange functions.

17. A method of communication between a host communication device and a slave communication device, wherein the host communication device comprises:
a reference unit;
a first wireless communication unit; and
a first control unit configured to control the reference unit and the first wireless communication unit;
wherein the first wireless communication unit is configured to establish a wireless communication connection and perform data exchange according to a predetermined protocol; and
wherein the reference unit is configured to send a first range reference signal wirelessly to thereby control a communication range of the wireless communication connection;
wherein the first range reference signal contains information about the host communication device and information about the communication range; and
a slave communication device configured to determine whether a distance between the host communication device and the slave communication device satisfies a predetermined range according to the received first range reference signal, and if so, the host communication device and slave communication devices quickly establish a wireless communication connection and exchange data according to a predetermined protocol;
the method comprising:
Step A: the host communication device sending a range reference signal, the slave communication device receiving the range reference signal;
Step B: the slave communication device determining whether the distance satisfies the predetermined range, and if so, executing Step C, otherwise, executing Step A;
Step C: establishing wireless communication between the host communication device and the slave communication device and exchanging data.

18. The method of claim 17,
wherein Step A comprises:
Step A1: the host communicating device converting the information about the host communication device into the first range reference signal in the form of a low-frequency magnetic signal and transmitting the low-frequency magnetic signal, and executing step A2;
Step A2: the slave communicating device receiving the low-frequency magnetic signal and converting it into an electrical signal, and executing step B;
wherein Step B comprises:
Step B1: the slave communicating device authenticating the host communication device according to information about the host communication device contained in the electrical signal;
Step B2: the slave communication device determining the threshold value of the electrical signal, if the threshold value of the electrical signal is equal to or greater than the predetermined threshold value, then executing step C, otherwise, executing Step A1.

19. The method of claim 17, wherein
Step A comprises:
Step A1′: the host communication device converting the information about the host communication device into ultrasonic range reference signals of at least three different ultrasonic frequencies, and substantially simultaneously transmitting the ultrasonic signals of at least three different frequencies, and executing step A2′;
Step A2′: the slave communication device receiving the ultrasonic signals of at least three different frequencies, and recording time differences of the ultrasonic signals of different frequencies reaching the slave communication device, and executing step B;
wherein Step B comprises:
Step B1′: the slave communication device demodulating the ultrasonic signals and obtaining the information about the host communication device, and authenticating the host communication device according to the information about the host communication device;
Step B2′: the slave communication device calculating the distance between the host communication device and the slave communication device according to the time differences, and determining whether distance between the host communication device and the slave communication device satisfies the predetermined range, and if so, executing step C, otherwise, executing step A1′.

20. The method of claim 17, wherein Step C is selected from a first group, a second group, or a third group,
wherein the first group comprises:
Step C1: the slave communication device sending back an access confirmation message of the slave communication device to the host communication device via the second wireless communication unit according to the received information about the host communication device;
Step C2: the host communication device receiving the access confirmation message via the first wireless communication unit and establishing wireless communication between the host communication device and the slave communication device through the first wireless communication unit and the second wireless communication unit;
wherein the access confirmation message contains information about the host communication device;
wherein the second group comprises:
Step C1′: the slave communication device sending back the access confirmation message of the slave communication device to the host communication device via second wireless communication unit according to received information about the host communication device;
Step C2′: the host communication device receiving the access confirmation message via the first wireless communication unit and stopping transmitting the range reference signals; and
Step C3′: establishing the wireless communication between the host communication device and the slave communication device through the first wireless communication unit and the second wireless communication unit;
wherein the third group comprises:
Step C1″: the slave communication device stopping receiving the range reference signal;
Step C2″: the slave communication device sending back the access confirmation message of the slave communication device to the host communication device via the second wireless communication unit according to the received information about the host communication device;
Step C3″: the host communication device receiving the access confirmation message via the first wireless communication unit, and establishing the wireless communication between the host communication device and the slave communication device through the first wireless communication unit and the second wireless communication unit.
